(19) United States
(12) Patent Application Publication
(10) Pub. No.: US 2025/0165998 A1
(43) Pub. Date: May 22, 2025

(54) SYSTEM AND METHOD FOR CONTROLLING PLANT REPRODUCTIVE STRUCTURES THINNING

(71) Applicant: MATA AGRITECH, LTD., Nov (IL)

(72) Inventors: Menachem Yosef FRIDMAN, Nov (IL); Sharya FRIDMAN, Nov (IL); Nachshon FRIDMAN, Nov (IL); Israel David FRIDMAN, Sde-ilan (IL); Ido FRIDMAN, Sde-ilan (IL)

(73) Assignee: MATA AGRITECH, LTD., Nov (IL)

(21) Appl. No.: 18/843,021

(22) PCT Filed: Mar. 6, 2023
(86) PCT No.: PCT/IL2023/050226

§ 371 Date: Aug. 30, 2024

Related U.S. Application Data
(60) Provisional application No. 63/318,400, filed on Mar. 10, 2022.

(51) Int. Cl. G06Q 30/0203; A01G 3/08; G06Q 50/02

(52) U.S. Cl. CPC G06Q 30/0203; A01G 3/08; G06Q 50/02

(57) ABSTRACT

According to some aspects of the present invention a system for controlling thinning of plant reproductive structures (e.g., fruits and/or bloom) includes a processing unit; and a non-transitory media readable by the processing unit. The media storing instructions that when executed by the processing unit, cause the processing unit to generate a thinning policy based on analysis of data that may include one or more of the following: strains/cultivars, geographical area, topographic, soil, farming practice, climate, season, target market preferences, and trade. The thinning policy may include the determination of a desired reproductive structures density which may mean the rate (percent) of flowers/fruits to be removed and the distance between flowers/fruits. Typically, the density is related to the location of fruits/flowers. It can be spatial, linear, tree average, branch average, or average per unit length. The thinning policy may be determined according to strains/cultivars and geographic.

### CROSS-REFERENCES TO RELATED APPLICATIONS

This application claims priority of the U.S. provisional patent application No. 63/318,400, filed on Mar. 10, 2022, entitled SYSTEM AND METHOD FOR CONTROLLING PLANT REPRODUCTIVE STRUCTURES THINNING.

### TECHNICAL FIELD

The present invention relates to pruning, more particularly, the invention relates to automated control of fruit/flower thinning.

### BACKGROUND

External plant structures such as leaves, stems, roots, flowers, fruits and seeds are known as plant organs. Each organ is an organized group of tissues that works together to perform a specific function. Some of these organs are reproductive structures. These structures can be divided into two groups: sexual reproductive and vegetative. Sexual reproductive structures include flower buds, fruit and seeds.

Removal of flowers or young fruit (thinning) is done to allow rapid growth of the remaining fruits and to avoid such a large crop hampering the crop in the following year. Thinning is done by hand, mechanically, or chemically. Hand-thinning of flowers may be more predictable than mechanical or chemical thinning but relies heavily on human labor which may involve complications and high costs. The cost of thinning is very high compared to most operations involved in cultivation apart from harvesting.

Thinning has a paramount effect on the return obtained from the plot, due to its effect on the amount and the size of the fruit. Lack of thinning results in average fruit size decrease, while excessive thinning reduces the amount of fruit. As a result, the yield decreases.

Market preferences may dictate a particular fruit size range with a significantly higher return compared to the return obtained for fruit size outside this range. Thus there exists growers' need to meet market requirements by the implementation of reliable high throughput techniques that may allow appropriate response to changing environmental conditions as well as to market trends.

Today, the thinning in fruit trees, such as peach and nectarine is carried out manually and usually under general, inaccurate, and unsystematic guidelines. Sometimes manual thinning is preceded by inaccurate mechanical thinning with a machine that simply cuts some of the bloom or fruit, however, the mechanical thinning is not suitable for all varieties and most farmers do not use it regularly. A typical example according to the existing practice of a combined mechanized and manual thinning is of a tree with 2,000 flowers undergoing a preliminary mechanical thinning that removes between 20 and 40 percent of the flowers, leaving about 1,500 young fruits to develop (apparently, without reference to the depreciation there is between the flowering stage and fruiting). If applicable to the variety, additional mechanical thinning may be carried out to remove young fruits, in which 20-30 percent of the young fruits are removed, which leaves about 1,100 young fruits on the tree. From this stage, the thinning is done manually to reduce the amount of fruit to a range between 300-550 depending on the variety. This means that manual thinning at a high level of performance requires between 5-8 working days of one worker per dunam after the preliminary mechanical thinning as described above. The cost of a worker in Israel per day is approximately NIS 260, which is according to the February 2022 exchange rate, roughly USD 80. When preliminary mechanical thinning is not applied, the thinning time per dunam can reach up to 9-11 working days.

List of problems related to existing techniques include the need for a large workforce that is not always available; lack of professionalism of seasonal workers; human workers distractions (e.g., by cellular phones); thinning policy being applied does not correspond to market preferences; high dependence on experience and knowledge that is not available to many farmers and workers. Difficulty in being able to weigh all the parameters that affect the thinning policy results. Even a knowledgeable and experienced farmer may not be able to take all the parameters into account. There is also a difficulty in transferring knowledge from the farmer to the workers. Manual thinning is a slow and expensive operation. Difficulty in performing the operation at the right time due to constraints such as: need to handle thinning of several varieties in parallel or performing other operations in the orchard to which the manpower is directed. It is crucial to perform thinning at the right time to avoid wasting the tree resources on excess fruit rather than directing tree resources precisely to the correct amount of fruit allowing to achieve a crop that fits market preferences. Working hours limit.

There are cases where chemical thinning is applied, however it lacks precision and is not suitable for all types of crops (e.g., peaches and nectarine). Mechanical thinning equipment, sometimes mounted on a vehicle, performs random and inaccurate thinning, typically as preliminary operation to manual thinning but usually not replacing it. Thus, precise manual thinning is indispensable to reduce the amount of fruit on the tree to the desired final amount.

In order to overcome the problems mentioned above a number of solutions have been proposed involving the use of thinning robots. In US20130204437 Koselka et al proposed a robotic system for harvesting, pruning, culling, weeding, measuring and managing of agricultural crops. The proposed system utilizes machine-vision using cameras that identify and locate the fruit on each tree, points on a vine to prune, etc.,. The robots may be utilized for measuring agricultural parameters or aid in managing agricultural resources. The cameras may be coupled with an arm or other implement to allow views from inside the plant when performing the desired agricultural function. The robot moves through a field first to “map” the plant locations, number and size of fruit and approximate positions of fruit or map the cordons and canes of grape vines. Once the map is complete, a robot or server creates an action plan that a robot may implement. An action plan may comprise operations and data specifying the agricultural function to perform. In U.S. Pat. No. 10,757,861 Robertson et al describe a robotic fruit picking system that includes an autonomous robot with a positioning subsystem that enables autonomous positioning of the robot using a computer vision guidance system. The robot also includes at least one picking arm and at least one picking head, or other type of end effector mounted on each picking arm to either cut a stem or branch for a specific fruit or bunch of fruits or pluck that fruit or bunch. A computer vision subsystem analyses images of the fruit to be picked or stored and a control subsystem is programmed with or learns picking strategies using machine learning techniques. A quality control (QC) subsystem monitors the quality of fruit and grades that fruit according to size and/or quality. The robot has a storage subsystem for storing fruit in containers for storage or transportation, or in punnets for retail. Zhang Fei et al describe in CN207083570 trees cutting trimming means, including crawler travel unit, arm, and an optical-fiber laser. Lee Chul Hee discusses in US2016050852 a robotic system having a laser beam generator to cut peduncles or thin blossoms and, more particularly, an agricultural robot system for recognizing fruits, flowers, or flower buds with camera input images and utilizing laser beams to cut peduncles or thin blossoms (burn or cure flowers or flower buds), thereby achieving speeding up pruning, and the non-contact operation to avoid damage to crops and contamination by viruses and germs as well as saving labor. Morcellet suggests in FR2994057 a robot with a movable structure moving between rows of vine grapes, a unit that collects images related to the vine grapes and branches, an image processing unit, a controlling unit connected with the processing unit directing a cutting unit to cutting points, a recording unit for recording images to utilized to direct a laser beam on the vine grapes and branches. In WO2016014552 an end-effector device and automated selective thinning system described by Lyons et al includes vision acquisition hardware, kinematic targeting and heuristic programming, a robotic arm, and a pomologically designed end-effector. The system is utilized to improve efficiency for the fruit-thinning process in a tree orchard, such as peach thinning. By automating the mechanical process of fruit thinning, selective fruit-thinners can eliminate manual labor inputs and further enhance favorable blossom removal. Automation used in conjunction with a heuristic approach provides improvements to the system. The system may be configured as a robotic arm or as a handheld system by including a battery and switching microcontroller with handle or wrist straps. Handheld thinning devices that are mechanical in nature may also be part of the system. As of Feb. 18, 2022 Aigritec offers in

https://www.aigritec.com/service/precision-thinning/a robot platform and a dedicated end-effector for precision thinning to remove exceeding fruits on trees to abate fruit-to-fruit competition allowing fruit enough room to grow, expose fruit to adequate sunlight, thus achieving better overall fruit quality. Aigritec describes use of a robotic vision system to accurately and robustly extract the geometry and semantic information from the working scene in the orchard environment—ensuring that neither the fruit nor the tree branch is damaged.

Despite the above describing great progress in the field of agricultural robotics, there are still needs that are not fulfilled in the existing techniques. Thinning robots with a robotic arm and a fruit/bloom cutter mounted on it operate in a repetitive sequence of motions which significantly slows down the operation. Mechanical/robotic thinning may be limited by difficult access to bloom and fruit as a result of tree branch structures. With the nonuniform tree branch structure the robot operation can become quite a challenge. In some cases, to facilitate the use of robots, tree branches are pruned to limit branch structure depth to allow robotic arm reach, i.e. a two-dimensional (axial) trees row design. This requires ongoing work to maintain the branch structure suitable for robots' operation. This may involve the tree's resources being wasted. Many crops are not suitable to a tree row axial design with a typical branch structure thickness of about 80 cm.

In reviewing the existing solutions above, it seems that there is no reference for accommodating the thinning operation to certain growth conditions and relevant market preferences in order to maximize profit.

The terms “users”, “farmers” and “growers” may be used interchangeably hereinafter.

The terms “pruning unit”, and “pruning system” may be used interchangeably hereinafter.

The terms “geographical area” and “geographical zone” may be used interchangeably hereinafter.

The terms “cultivar”, “variety”, and “strain” may be used interchangeably hereinafter.

### SUMMARY OF EMBODIMENTS OF THE INVENTION

It seems that the existing solutions fail short to fit thinning to varying growth conditions and relevant market preferences to allow maximizing the profit. The present inventors have devoted many years to research and experiments to develop the present invention aimed to overcome the challenges related to thinning and the disadvantages of the existing techniques.

According to some aspects of the present invention a system for controlling thinning of plant reproductive structures (e.g., fruits and/or bloom) includes a processing unit; and a non-transitory media readable by the processing unit. The media storing instructions that when executed by the processing unit, causes the processing unit to generate a thinning policy based on analysis of data that may include one or more of the following: strains/cultivars, geographical area, topographic, soil, farming practice, climate, season, target market preferences, and trade. The thinning policy may include determination of a desired reproductive structures density which may mean the rate (percent) of flowers/fruits to be removed and the distance between flowers/fruits. Typically, the density is related to the location of fruits/flowers. It can be spatial, linear, tree average, branch average, average per unit length. Thinning policy may be determined according to strains/cultivars and geographics. This may encompass parameters like soil, climate, sunlight, latitude, altitude, drainage, history of soil treatment; previous crops; irrigation fertilization methods, water quality; alluvium; soil loss; sediments; groundwater; air and soil pollution; and soil condition e.g. erosion and compaction. The processing unit generates output derived from the thinning policy which can be recommendations provided to the farmer or signals sent to control the operation of thinning equipment.

According to some embodiments of the invention the thinning system includes one or more reproductive structures (e.g., bloom or fruit) detection units communicatively coupled with the processing unit. Such detection units may include cameras, sensors, lidars, radar, image processing and analysis modules, machine learning modules, artificial intelligence, databases, and communication modules. The processing unit may calculate temporal reproductive structures densities, (including zero time), based on input received from the reproductive structures detection unit. The thinning policy includes inferences based on a gap between the temporal densities and the desired reproductive structures density.

According to some embodiments, the system includes a tree structure detection unit according to which the processing unit generates temporal models of one or more parts of each tree based on input received from the reproductive structures detection unit and the tree structure detection unit. Such detection units may include cameras, sensors, lidars, radar, image processing and analysis modules, machine learning modules, artificial intelligence, databases, and communication modules.

The thinning policy may include determination of required fruit size at harvest and/or fruit size to be pruned at thinning. The policy may include inferences derived from input received from at least one recommendation system based on user preferences that may include data on one or more of the following: strains/cultivars, geographical area, topographic, soil, irrigation, climate season, target market preferences, and trade. The policy may include inferences derived from input provided by the user, input received from various detectors including cameras, thermal, image processing systems, sound, radar, lidar and so on. Moreover input can be received from databases, internet, and weather monitoring equipment. The input may include historical data. For processing input and generating the thinning policy, the processing unit may utilize modules of machine learning, artificial intelligence, artificial decision making, data mining and handling big data.

In some embodiments of the invention the thinning system includes a computerized controller receiving output derived from the thinning policy and temporal reproductive structures densities from the processing unit. The system may include one or more preliminary pruning units and one or more primary pruning units both controlled by the controller. The thinning policy includes determination of a preliminary pruning reproductive structures density threshold. The preliminary pruning unit is activated if the temporal density is above the threshold and operates until the temporal density is below the threshold below which the primary pruning unit is activated and runs until the temporal density reaches the reproductive structures desired density value according to the thinning policy. The primary pruning unit may include a number of laser beam emitters, each is coupled with one or more laser beam direction and intensity control units. Some of the direction and intensity control units may be based on optics. The activation of the pruning units may be separately for separate parts of the tree, among other things because the density of the reproductive structures can be different between different parts of the tree.

The thinning system may be mounted on a vehicle. In order to prevent possible collateral damage from laser beams or from other parts, the system may include protective means such as protective barriers, motion detectors, and image analysis devices. The detectors and imaging devices may be used to stop the thinning system operation, for example when there is a detection of objects, animals, or humans approaching the work area, or in case there is a detection of objects in the working area that should be protected such as bird nests or traps. Detectors may include cameras, thermal, image processing, sound, radar, lidar, and others that may be developed in the future. Machine learning, artificial intelligence, databases, communication modules, and historical data may be utilized as well. Some detectors may be stationary permanently located in the working area, or portable between different working zones. Some detectors may be fixed to the thinning system, mounted on vehicles, or on aircrafts such as drones and balloons. According to some examples, there is a use of cell phones that are communicatively connected to the thinning system for sending warning signals about the possibility of peripheral damage, for example, objects detected by the phone camera.

Pruning units may include one or more plant parts detection units, and a processing unit receiving input from the plant parts detection unit. A non-transitory media readable by the pruning processing unit, the media storing instructions that when executed by the processing unit, causes the processing unit to generate one or more models of a structure of one or more hidden sections of a plant part based on the input from the plant parts detection unit. The pruning processing unit may be used to define an optimal cutting point in reproductive structures pruning based on the hidden parts model and input received from the plant parts detection unit which may include cameras, thermal imaging, image processing, sound processing, radar, lidar, and other types of detectors that may be developed in the future. Machine learning, artificial intelligence, training modules, databases, communication modules, historical data and big data may be utilized as well.

Pruning units can include mechanical, hydraulic, pneumatic, robotic, laser, electrical mechanisms, and more. In addition to reproductive structures some embodiments of the invention can also be utilized for pruning branches or other plant parts.

A method according to some aspects of the invention, involving using an Artificial Intelligence (AI) module includes generating a thinning policy and generating output derived from the thinning policy. The thinning policy is based on analyzing data which may include strain/cultivar, geographical area, topographic, soil, farming practice, climate, season, target market preferences, and trade. According to some embodiments the method includes determining a desired reproductive structures density; calculating temporal reproductive structures densities based on input received regarding reproductive structures; and generating inferences based on a gap between the temporal densities and the desired reproductive structures density value. The method may include generating temporal models of one or more parts of each tree based on the input regarding reproductive structures and input regarding tree structure. The method may include determining fruit size at harvest and/or determining fruit size to be pruned at thinning. In some examples embodying the invention, the method includes generating inferences derived from input received from one or more recommendation systems, based on user preferences including data on strain/cultivar, geographical area, target market preferences, and trade.

In some cases the output derived from the thinning policy is used for controlling at least one pruning system. In some embodiments of the invention the method includes determining a preliminary pruning reproductive structures density threshold; preliminary pruning; and primary pruning. The preliminary pruning is carried on as long as the temporal density is above or equal to the threshold. The primary pruning takes place when the temporal density is below the threshold and above the reproductive structures desired density. The primary pruning may involve emitting laser beams from a number of laser beam emitters. The preliminary pruning and the primary pruning in case of receiving at least one alert indicating possible collateral damage due to the preliminary pruning or the primary pruning.

In some embodiments, the method includes detecting one or more plant parts and generating one or more models of a structure of at least one hidden section of one or more plant parts based on the detecting plant part(s). The method may include defining an optimal cutting point in reproductive structures pruning based on the model of a structure of hidden section(s) and the detecting of plant part(s).

### BRIEF DESCRIPTION OF DRAWINGS

Preferred embodiments, features, aspects and advantages of the present invention are described herein in conjunction with the following drawings:

FIG. 1. illustrates schematically a fruit and a stalk partially hidden by foliage

FIG. 2. is a schematic flowchart showing operation of a thinning system with two types of pruning units according to some embodiments of the invention

FIG. 3. illustrates schematically a thinning system with protective physical barriers and two types of pruning units according to some embodiments of the invention

FIG. 4. illustrates schematically a tree where branch pruning is to be made

FIG. 5. illustrates schematically a characterization and recommendation system according to some embodiments of the invention

FIG. 6. illustrate schematically man-machine interface of a characterization and recommendation system according to some embodiments of the invention

In order to leave no room for doubt, the elements shown in the illustrations of the present patent application are presented in a manner that enables understanding them clearly, and the scales, size relations, and shapes are not in any way limiting their embodiment.

### DETAILED DESCRIPTION OF EMBODIMENTS

Thinning has a paramount effect on the return obtained from the plot, due to its effect on the amount and the size of the fruit. Market demand may dictate a particular fruit size range with a significantly higher return compared to the return obtained for fruit size outside this range. Thus there exists growers' need to meet market requirements by the implementation of reliable high throughput techniques that may allow appropriate response to changing environmental conditions as well as to market trends. Today, the thinning in fruit trees, such as peach and nectarine is carried out manually and usually under general, inaccurate, and unsystematic guidelines. Sometimes manual thinning is preceded by inaccurate mechanical thinning with a machine that simply cuts some of the bloom or fruit. Problems related to existing techniques include the need for a large workforce that is not always available; lack of professionalism of seasonal workers; human workers are prone to be distracted (e.g., by cellular phones); implementation of thinning policy that results in a mismatch of the crop to market preferences; high dependence on experience and knowledge that is not available to many farmers and workers. Difficulty in being able to weigh all the parameters that affect the thinning policy results. Even a knowledgeable and experienced farmer may not be able to take all the parameters into account. There is also a difficulty in transferring knowledge from the farmer to the workers. Manual thinning is a slow and expensive operation. Difficulty in performing the operation at the right time may arise due to constraints such as: need to handle thinning of several varieties in parallel or performing other operations in the orchard to which the manpower is directed. It may be crucial to perform thinning at the right time in order to avoid wasting the tree resources on unnecessary excess fruit, rather than directing tree resources precisely to the correct amount of fruit to achieve a crop that fits market preferences. There are cases where chemical thinning is applied, however it is not precise and not suitable for all types of crops (e.g., peaches and nectarines). Despite the great progress in agricultural robotics, thinning may be limited by difficult access to bloom and fruit as a result of tree branch structures. Moreover with the nonuniform tree branch structure the robot operation can become quite a challenge. It seems that the existing solutions fail short to fit thinning to varying growth conditions and relevant market preferences to allow maximizing the profit. The present inventors have devoted many years to research and experiments to develop the present invention aimed to overcome the challenges related to thinning and the disadvantages of the existing techniques.

According to some aspects of the present invention a system for controlling thinning of plant reproductive structures (e.g., fruits and/or bloom) includes a processing unit; and a non-transitory media readable by the processing unit. The media storing instructions that when executed by the processing unit, causes the processing unit to generate a thinning policy based on analysis of input regarding strains/cultivars, geographical area, target market preferences, and trade data. The thinning policy may include determination of a desired reproductive structures density which may mean the rate (percent) of flowers/fruits to be removed and the distance between flowers/fruits. Typically, the density is related to the location of fruits/flowers. It can be spatial, linear, tree average, branch average, average per unit length. Thinning policy may be determined according to strains/cultivars geology and geographics. This may encompass parameters like soil type, climate, sunlight, latitude, altitude, drainage, history of soil treatment, previous crops. irrigation methods, water quality, alluvium, soil loss, sediments, air, groundwater, and soil pollution, and erosion and compaction of soil. The processing unit generates output derived from the thinning policy. The output can be recommendations provided to the farmer or signals sent to control the operation of thinning equipment. A thinning system embodying the present invention may encompass such thinning equipment.

The processing unit may receive and process data pertaining to the strain/cultivars. The system may define the ideal or optimal number of fruits to be left on the tree based on a historical database, characterization and recommendation systems, and observation of the tree. The system may prioritize the various parameters relevant to the thinning in order to reach the average fruit required according to the strain/cultivar, in order to reach an average fruit size that will maximize profits according to the relevant market preferences. The prioritization of parameters can vary among different strains/cultivars.

The strain/cultivar may be identified by a characterization questionnaire to be filled out by the farmer and/or utilizing the processing unit and the plant parts detection unit. The number of strains/cultivars can be very large however group cataloging of several strains/cultivars with similar characteristics may be applied. It is possible that the system will utilize a learning module to catalog non-identified strains/cultivars having characteristics that can be associated with one of the groups for allowing adjusting the thinning accordingly.

Thinning can be performed according to a strain/cultivar-adjusted policy and additional considerations that can be taken into account like the position of the branch in relation to the trunk; the distance of the fruit peduncle from the trunk; location of the branch relative to the sun, e.g, exposure to sunlight, shad, position relative to solar orbit, and sun angle; branch diameter and length; the position of the fruit on the branch; the quality of the fruit on the branch; analysis of young fruit content, e.g, texture, that can be used to predict fruit ripening; color prediction of the fruit based on the strain/cultivar; and robustness of the branch, i.e. its ability to carry the weight of the fruit. Demonstration of parts that can vary in thinning policies of different varieties relating to a branch 0.9 cm in diameter and 40 cm long is as follows.

In a variety where the fruit grows without difficulty, the branch can carry fruit every 7 cm on the same side or every 3 cm on opposite sides of the branch. Where the branch begins it may carry more fruits, e.g, 2 fruits opposite each other at the same point. The same branch in the variety where sizable fruits grow readily but do not get color so well, larger space among fruits would be required to allow more fruit sunlight exposure. In a variety where achieving sizable fruit is difficult, it would be advisable to allow less fruit on the branch. For example, allow 9 cm between fruits (instead of 7 cm), and only on the same side of the branch in order to reduce competition between fruits. In a variety that tends to produce less fruit, smaller fruits would be left to grow on the branch. In times of high demand and expectations for high prices, it may be advisable to leave fruits with certain defects (e.g, appearance related defects).

A system according to some embodiments of the invention may include a unit for identifying size and defects in the fruit, communicatively coupled with the processing unit. The unit for identifying size and defect may include cameras, thermal imaging, image processing, sound processing, radar, lidar, and other types of detectors that may be developed in the future. Machine learning, artificial intelligence, training modules, databases, communication modules, historical data and big data may be utilized as well.

According to some embodiments, input regarding market prices and demand is obtained from a characterization and recommendation system, market analyses, competitors data, and previous performance, in order to better finetune the thinning policy to maximize profit. The parameters may be weighted for each group of varieties with similar characteristics based on the data collected from the field, system data, and data from the characterization and recommendation systems, in order to produce maximum value by using the parameters optimally to reach the correct number of fruit on the tree for each variety. In some embodiments, machine learning and feedback are utilized. This may include counting the fruit left on the tree after the thinning for analysis and continuous improvement of system performance, including better utilization of input received from recommendation systems. The characterization and recommendation systems may take into account the user's desires and preferences, strain, trade data, geographical data, weather data, topographic data, etc to provide valuable input to be analyzed by the processing unit.

In some examples, the thinning system includes a preliminary mechanical pruning unit.

Three-dimensional modeling of the tree is being generated by the system in order to detect young fruit and/or bloom. Then the system locates areas with a large amount of fruit/bloom where the preliminary pruning unit is operated to partially remove the fruit load in this area to allow more efficient operation of the primary laser beam-based pruning unit. An assessment carried out by the processing unit is done of the result of the preliminary pruning and its effect on the whole efficiency of the thinning. For example, if the laser unit deviates from its target efficiency according to the thinning policy, the mechanical thinning unit operation will be altered to improve it. The efficiency may be defined in various ways, for example by the amount of fruit removed per unit of time. An example of such interplay between the performance of the preliminary unit and the primary (laser) unit is when it is detected that the laser unit removed less than the desired amount of fruit i.e, its efficiency is too low. In the next run, the mechanical unit will remove fewer fruits, leaving more fruits to be removed by the laser unit. In case it is detected that the laser unit removes too much fruit, the operation of the mechanical unit will be altered to remove more fruit leaving less fruit to be removed by the laser unit.

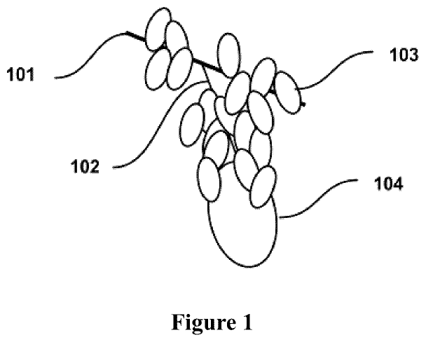

The laser pruning unit is typically aimed to perform precise thinning in accordance with the thinning policy. In certain embodiments of the invention, a laser pruning unit is installed on a construction, and includes a number of laser emitters to facilitate access to the fruit or flowers on the tree. Each laser emitter is coupled to an optical computerized laser beam directing unit. The laser beam directing unit receives, among other things, visual data about the size of the target such as the diameter of the stalk. The beam direction unit may adjust the laser wavelength to precisely match the diameter of the stalk in order to eliminate collateral damage i.e. deviation of the laser beam from the stalk to be cut. In some examples embodying the invention a cutting point module unit is utilized with machine learning for identifying the target (e.g., stalk). The cutting point module may be coupled with a thermal camera for detecting temperature differences between tree parts (e.g, leaves) and the target, in case the target is hidden, to allow directing the laser beam toward the target. In some cases, a blower is used to move foliage that hides the cutting point (target). The cutting point module may utilize Artificial Intelligence in order to generate a virtual target model based on exposed target parts input. For example as illustrated in FIG. 1, when only a partial identification is possible of a fruit branch 101 and the tip of stalk 102 and/or fruit 103 protruding through leaves 104. The cutting point module may take into account the angle at which the fruit is hung, the diameter of the exposed part of the stalk, and statistical data to create a virtual target model. The laser unit may be coupled to lidar for measuring the distance to the target (cutting point). Cameras also may be coupled to the laser system with an image processing unit for generating a three-dimensional model of the tree. The number and location of the cameras may be adjusted to allow generating of accurate modeling of a complicated tree structure.

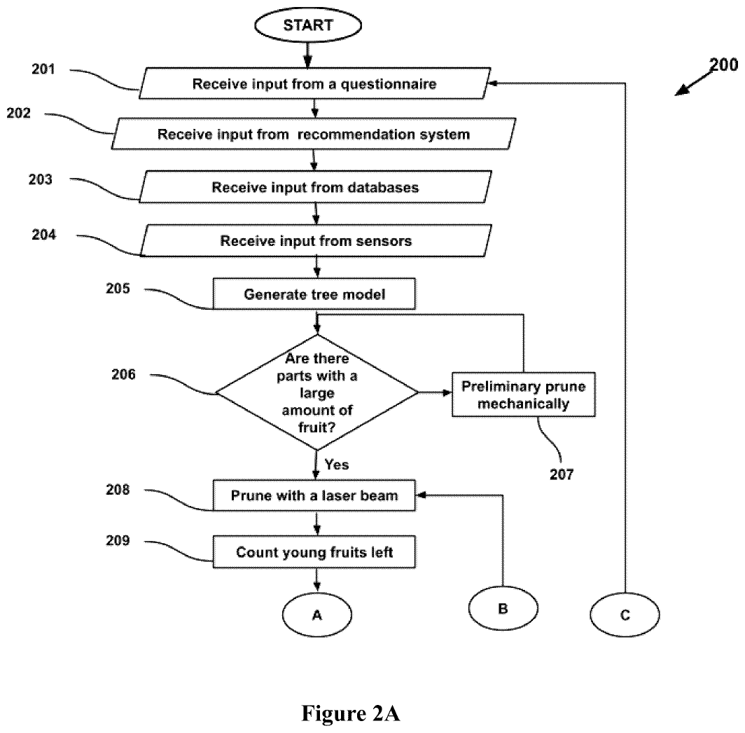

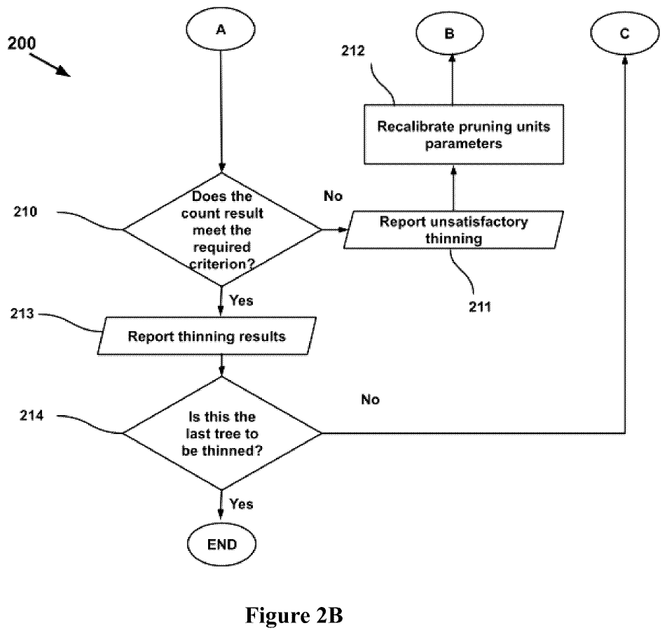

A possible flowchart 200 for the operation of the above described thinning system with two types of pruning units appears in FIGS. 2A-2B. One or more processing units receive data input entered by a user(s) filling out a questionnaire 201. This data characterizes the plot to be thinned such as strain/cultivar, geographical area, topographic, geology, soil, pests, vegetation indices, diseases, farming practice including fertilization irrigation, pests control, crop plan, plant spacing, pollination, farming approach (e.g organic farming, sustainable agriculture, service/cover crops, double-crop, precision), soil/crop sampling, evapotranspiration, yield, crop planted date, fertilization, tillage, vegetation cover, agronomist's Instructions, target market preferences, and trade. In addition, the processing unit(s) receive input 202 from recommendation system that may utilize user-entered information or any information that is received and found relevant to characterize the relevant needs, such as information derived from the Internet of Things (IoT), telemetry, location (possibly GPS/GLONASS/GNSS/DGPS) aerial/satellite imaging, albedo, ancillary data, pests, pollination, farming approach (e.g organic farming, sustainable agriculture, service/cover crops, double-crop, precision), soil/crop sampling, yield. So the information that the processing system receives comes not only from the user. The recommendation system can take advantage of big data, machine learning, metadata, fact-checking, and artificial intelligence. The processing unit may receive the above data input 203 also directly from the network and databases such as GIS and EROS (Landsat). Data 204 may be received from sensors remote or proximal such as capacitance, pH, climate, imaging, conductivity, soil, electro-optical, georeferencing, moisture, radar, lidar, reflectance, electromagnetic, and optical. The above data is used to generate a thinning policy by the processing unit. This includes model generation 205 of the trees to be thinned and determination 206, depending on the fruit load (density), whether the thinning should start with a preliminary mechanical pruning 207, until detection of fruit load suitable for laser pruning 208. The thinning policy includes one or more criteria, such as a desirable fruit load to end thinning that until it is reached by remaining fruit counting 209, the thinning continues. If verification 210 whether the fruit count 209 matches the thinning termination criterion is negative, the system reports 211 the result to the user and recalibrates 212 the operation of the mechanical and the laser pruning units. Recalibration may include utilizing machine learning and artificial intelligence. If verification 210 whether the fruit count 209 matches the thinning termination criterion is positive, the system reports 213 the thinning result to the user and checks 214 whether this is the last tree for thinning based on input fed by the user or obtained otherwise e.g database or aerial imaging service. If this is not the last tree to be thinned, the process starts again for the next tree, otherwise, the thinning operation ends.

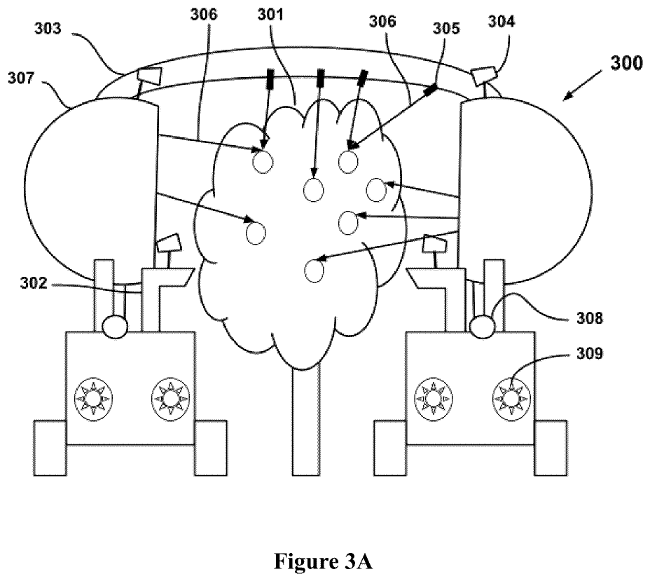

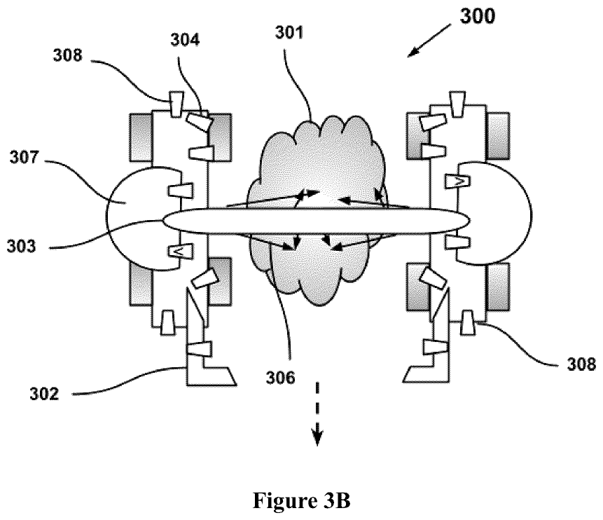

The thinning system may include protective measures to prevent unwanted damage due to the laser beam, including a physical barrier made of heat-resistant material that can absorb laser beam energy. Motion detectors may be utilized from which signals are received in the system to stop the system operating if a foreign object approaches a danger area. Cameras may be located at heights, stationary, or on drones to detect the approach of various objects to the work area to stop the system from operating in the event of a danger detection. Image analysis may be used to identify objects on the tree such as pest traps, and bird nests to stop the system operation. An example of thinning system 300 with protective physical barriers is depicted during laser thinning of tree 301 in front and top views in FIGS. 3A and 3B respectively. System 300 includes preliminary mechanical pruning unit 302 designed for rapid removal of excess fruit prior to the activation of main laser pruning unit 303. The two pruning units are operated by a computerized controller (not shown) in accordance with the thinning policy ditto taking into account, inter alia, input from sensors such as cameras 304 mounted on a system 300. Laser pruning unit 303 includes laser emitters 305 (some are shown), which can be aimed at different angles for directing laser beams 306 towards cutting points (targets) for removing the excess fruit. To prevent collateral damage by laser beams 306, system 300 is equipped with domed physical barriers 307. Image sensors 308, (e.g cameras) are used for unmanned/remote navigation, while for navigation in limited lighting conditions, headlights 309 are used as well.

The thinning system may be installed on an autonomous vehicle (such as a tractor) whose movement will be controlled according to the thinning operation. Vehicle direction may be based, among other things, on GPS. In some embodiments of the invention, the operation of the system is recorded including landmarks of the locations of the system operation. This may allow among other things, learning based on past performance correlated to locations, sometimes in combination with input from lidar and motion sensors.

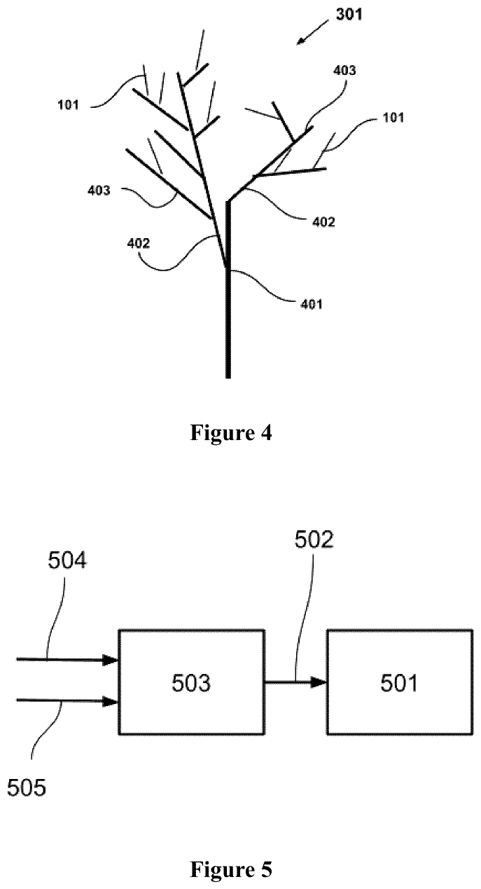

The present invention is not limited to the pruning of a reproductive structure. It can be utilized for pruning branches. Branch pruning is done typically during the winter, a few months before the thinning of the reproductive structures. For example as illustrated in FIG. 4, tree 301, branch pruning that is carried in three main stages: rapid pruning of skeletal (main) branches 402 emerging from trunk 401, usually over 60 mm thick, by heavy motor tools; pruning of “leading” branches 403, 10-60 mm thick emerging from skeletal branches 402 from which fruit branches 101 emerge, is done using manual and electric shears; and shortening of fruit branches 101, 1-10 mm diameter which is done using manual shears. Branch pruning and particularly shortening of fruit branches can be seen as part of the thinning because it reduces the amount of fruit on the tree prior to harvest. Like in fruit/bloom thinning, in fruit branch shortening, branch thickness and length are taken into account as well as the fruit carrying capacity of the leading branches to prevent fragments and cracks due to overload.

Aspects of the present invention allow fitting the amount of fruit according to the variety in order to reach an optimal average fruit size to maximize profits. A large number of parameters may be taken into account in real-time in a manner that is not practical in existing methods due to human ability limitations.

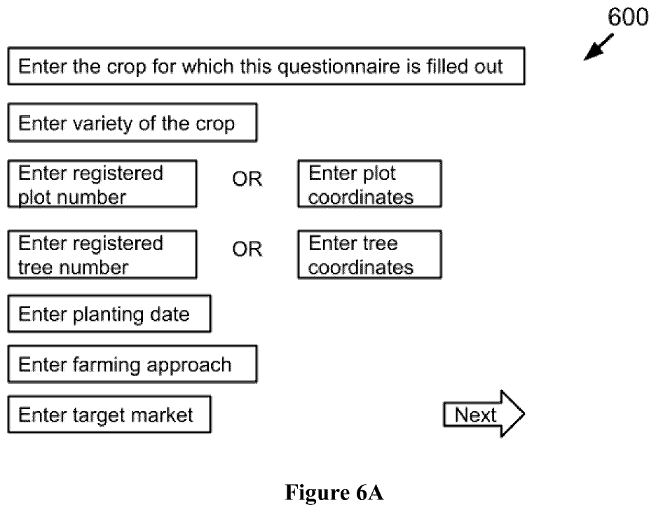

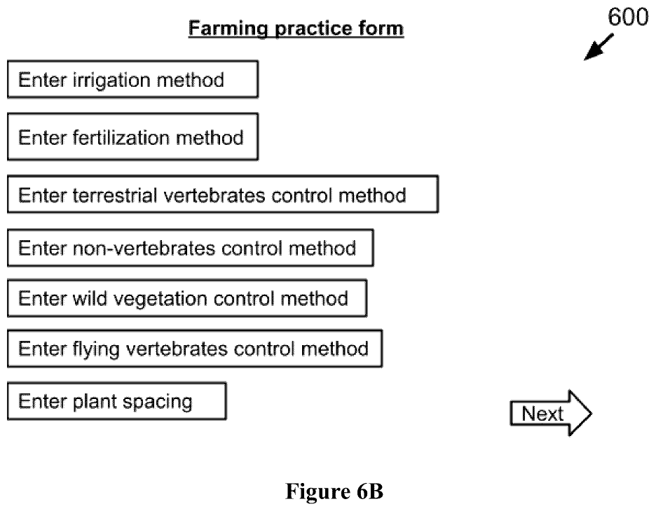

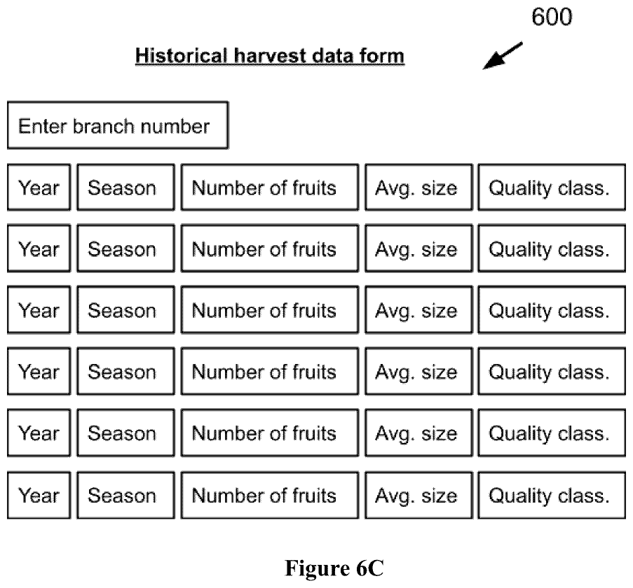

According to some aspects of the invention, utilizing characterization and recommendation systems allows adjusting the thinning to the relevant market and geographical area, among other things, by characterizing the user and providing him or her customized recommendations on how to realize the economic potential of his/her orchard, relying, among other things, on databases including past thinning results of the same variety, thinning results in that particular geographic area or plot, and relevant trade data that includes expected prices that may vary according to prospected crop, local competition, and import. Fruit of a preferred size in the market can be sold at price tens of percent higher than that of fruits with a size outside the preferred range. It should be borne in mind though that the thinning policy adequate to achieve preferred fruit size may vary for each variety. For example, in a specific variety 300 fruits should be left on the tree for harvest in order to reach an average desired fruit size of say, 65 mm. In another market, there may be a preference for smaller fruits of 55-60 mm size. In this case, over 380 fruits should be left for harvest. Such input may be fed to the processing unit via recommendation systems which can support decision-making specifically adapted for each region and for each farmer in real-time in a single tree or branch resolution. According to some embodiments of the invention, in order for the characterization and recommendation system to be oriented to an individual tree or branch, mapping and characterization by tree or branch is made with all relevant details mentioned above specifically for each tree or branch, including the location and specific details (e.g age, height, branch structure pests) of the individual tree. In the case of a branch, the details will also include the location of the branch in the tree. In some cases, the data is embedded into the tree model. It should be understood that each user (farmer), may utilize the system for a specific strain/cultivar in different cases, e.g., different plantations, different seasons, and different market conditions. Characterization of all of the trees and branches can be done by entering data by the user and/or autonomously relying on sensor input, image processing, combined with the use of artificial intelligence and machine learning. As illustrated in FIG. 5, according to some embodiments, for generating customized thinning policy, processing unit 501 receives customized input 502 from characterization and recommendation system 503 receiving input 504 fed by users and input 505 originating from databases, databases, IoT, etc. Input 504 may include filled questionnaires with data on strain, geographics, pests, pollination, farming approach, soil/crop sampling, yield, farming practice, target market, and past performance. Input 505 may include data on trade, weather, season, topographic, IoT, telemetry, location, aerial/satellite imaging, albedo, market preferences, and crop price forecasts. FIGS. 6A-6C depict an example of man-machine interface 600 e.g computer or smartphone screens used to fill out questionnaires by users of a characterization and recommendation system in some embodiments of the invention. Once the user has registered for the characterization and recommendation system he/she can fill in the details that appear in the fields to be filled out in order to receive customized input from the characterization and recommendation system. According to some examples, in some form fields, the user should choose from predefined options, e.g year, crop, season, quality classification, irrigation method, fertilization method, and more. In some examples, some fields are filled in automatically based on filling in other fields or previously filled-in data. For example, filling in the coordinates can result in the automatic filling of some or all of the fields in the framing practice form and the historical data form. FIGS. 6A-6C do not intend to limit the scope of the invention, these are merely a non-exhaustive example for illustration only. Questionnaires according to some embodiments of the invention may include additional questions, or may not include questions that appear in FIGS. 6A-6C. It should be understood by the reader that the present invention is not limited to the filling of forms by the user. In some embodiments of the invention, the data shown in the illustrative examples in FIGS. 6A-6C can be obtained in the characterization and recommendation system or directly in the processing unit from databases or sensors. For example the number of fruits in the harvest can be obtained from an image processing system. The location of the tree can be determined based on input from one or all of: image processing system, aerial photographs, satellite data, lidar, positioning system and so on.

Numerous other changes, substitutions, variations, and modifications may be ascertained by the skilled in the art and it is intended that the present invention encompass all such changes, substitutions, variations and modifications as falling within the scope of the appended claims.

Further, one skilled in the art will recognize that functional units in this description have been labeled as modules throughout the specification. The person skilled in the art will also recognize that a module may be implemented as circuits, logic chips or any sort of discrete component. Still further, one skilled in the art will also recognize that a module may be implemented in software which may then be executed by a variety of processor architectures. In embodiments of the invention, a module may also comprise computer instructions or executable code that may instruct a computer processor to carry out a sequence of events based on instructions received. The choice of the implementation of the modules is left as a design choice to a person skilled in the art and does not limit the scope of this invention in any way.

1. A system for controlling plant reproductive structures thinning, said system comprising:
a processing unit; and
a non-transitory media readable by said processing unit, the media storing instructions that when executed by said processing unit, causes said processing unit to generate a thinning policy,
wherein said policy is based on analysis of data selected from the group consisting of strain/cultivar, geographical area, topographic, soil, farming practice, climate, season, target market preferences, trade and combination thereof,
wherein said processing unit generates output derived from said thinning policy.

2. The system of claim 1, comprising at least one reproductive structures detection unit communicatively coupled with said processing unit,
wherein said thinning policy comprises determination of a desired reproductive structures density,
wherein said non-transitory media readable by said processing unit, the media storing instructions that when executed by said processing unit, causes said processing unit to calculate temporal reproductive structures densities based on input received from said reproductive structures detection unit, and
wherein said thinning policy comprises inferences based on a gap between said temporal densities and said desired reproductive structures density value.

3. The system of claim 2, comprising tree structure detection unit wherein said non-transitory media readable by said processing unit, the media storing instructions that when executed by said processing unit, causes said processing unit to generate temporal models of at least one part of each tree based on input received from said reproductive structures detection unit and said tree structure detection unit.

4. The system of claim 1, wherein said policy comprises determination of required fruit size at harvest.

5. The system of claim 1, wherein said policy comprises determination of fruit size to be pruned at thinning.

6. The system of claim 1, wherein said policy comprises inferences derived from input received from at least one characterization and recommendation system, based on user preferences.

7. The system of claim 6, wherein said characterization and recommendation system for assisting said processing unit in generating customized thinning policy, takes into account input received from questionnaires disseminated among farmers, wherein said questionnaires when filled comprise data selected from the group consisting of strain, geographics, pests, pollination, farming approach, soil/crop sampling, yield, farming practice, target market, and past performance, wherein said characterization and recommendation system further utilizes data input selected from the group consisting of trade, weather, season, topographic, IoT, telemetry, location, aerial/satellite imaging, albedo, market preferences, and crop price forecasts.

8. The system of claim 1, wherein said output comprises output for controlling at least one pruning system.

9. The system of claim 8, comprising said pruning system.

10. The system of claim 2, comprising:
a computerized controller receiving said output derived from said thinning policy and said temporal reproductive structures densities;
at least one preliminary pruning unit controlled by said controller; and
at least one primary pruning unit controlled by said controller,
wherein said thinning policy comprises determination of a preliminary pruning reproductive structures density threshold, said preliminary pruning unit is activated if said temporal density is above said threshold and operates until said temporal density is below said threshold below which said primary pruning unit is activated and runs until said temporal density reaches said reproductive structures desired density value.

11. The system of claim 10, wherein said primary pruning unit comprises a plurality of laser beam emitters, each of said emitters is coupled with at least one laser beam direction and intensity control unit.

12. The system of claim 10 mounted on a vehicle.

13. The system of claim 11, comprising at least one means to prevent possible collateral damage from laser beams, said means selected from the group consisting of protective barriers, motions detectors, image analysis devices, and combinations thereof.

14. A pruning unit for hidden plant parts comprising:
at least one plant parts detection unit;
a processing unit receiving input from said plant parts detection unit; and
a non-transitory media readable by said processing unit, the media storing instructions that when executed by said processing unit, causes said processing unit to generate at least one model of a structure of at least one hidden section of a plant part based on said input from said plant parts detection unit.

15. The pruning unit of claim 14, wherein said non-transitory media readable by said processing unit, the media storing instructions that when executed by said processing unit, causes said processing unit to define an optimal cutting point in reproductive structures pruning based on said model of a structure of at least one hidden section and said input from said plant parts detection unit.

16. A method for controlling plant reproductive structures thinning using an Artificial Intelligence (AI) module, the method comprising:
generating a thinning policy; and
generating output derived from said thinning policy,
wherein said policy is based on analyzing data comprising strain/cultivar, geographical area, target market preferences, and trade.

17. The method of claim 16, comprising:
determining a desired reproductive structures density;
calculating temporal reproductive structures densities based on input received regarding reproductive structures; and
generating inferences based on a gap between said temporal densities and said desired reproductive structures density value.

18. The method of claim 17 comprising generating temporal models of at least one part of each tree based on said input regarding reproductive structures and input regarding tree structure.

19. The method of claim 16, comprising determining fruit size at harvest.

20. The method of claim 16, comprising determining fruit size to be pruned at thinning.

21. The method of claim 16 comprising generating inferences derived from input received from at least one characterization and recommendation system, based on user preferences.

22. The method of claim 21, wherein said characterization and recommendation system for assisting said processing unit in generating customized thinning policy, takes into account input received from questionnaires disseminated among farmers, wherein said questionnaires when filled comprise data selected from the group consisting of strain, geographics, pests, pollination, farming approach, soil/crop sampling, yield, farming practice, target market, and past performance, wherein said characterization and recommendation system further utilizes data input selected from the group consisting of trade, weather, season, topographic, IoT, telemetry, location, aerial/satellite imaging, albedo, crop price forecasts, and market preferences.

23. The method of claim 16 wherein said output comprises output for controlling at least one pruning system.

24. The method of claim 18 comprising:
determining a preliminary pruning reproductive structures density threshold;
preliminary pruning; and
primary pruning,
wherein said preliminary pruning is carried out as long as said temporal density is above or equal said threshold, and wherein said primary pruning is carried out when said temporal density is below said threshold and above said reproductive structures desired density.

25. The method of claim 22, wherein said primary pruning comprises cutting said reproductive structures with laser beams emitted from a plurality of laser beam emitters

26. The method of claim 22 comprising stopping said preliminary pruning and said primary pruning in case of receiving at least one input indicating possible collateral damage due to said preliminary pruning or said primary pruning.

27. The method of claim 16 comprising detecting at least one plant part and generating at least one model of a structure of at least one hidden section of at least one plant part based on said detecting plant part.

28. The method of claim 27, comprising defining an optimal cutting point in reproductive structures pruning based on said model of a structure of at least one hidden section and said detecting at least one plant part.
